(19) United States
(12) Patent Application Publication
(10) Pub. No.: US 2025/0212168 A1
(43) Pub. Date: Jun. 26, 2025

(54) MULTICAST POSITIONING MEASUREMENT REPORTING IN SIDELINK

(71) Applicant: QUALCOMM Incorporated, San Diego, CA (US)

(72) Inventors: Marwen ZORGUI, San Diego, CA (US); Srinivas YERRAMALLI, San Diego, CA (US); Piyush GUPTA, Bridgewater, NJ (US); Alexandros MANOLAKOS, Athens (GR); Mukesh KUMAR, Hyderabad (IN); Rajat PRAKASH, San Diego, CA (US)

(21) Appl. No.: 18/847,112

(22) PCT Filed: Apr. 24, 2023
(86) PCT No.: PCT/US2023/019688

§ 371 Date: Sep. 13, 2024

(30) Foreign Application Priority Data
May 26, 2022 (GR) 20220100441

(51) Int. Cl. H04W 64/00; H04W 4/02

(52) U.S. Cl. CPC H04W 64/003; H04W 4/025

(57) ABSTRACT

In some implementations, a first user equipment (UE) may obtain, a positioning configuration related to the SL positioning session. The first UE may perform one or more measurements of one or more radio frequency (RF) signals at the first UE in accordance with the positioning configuration, wherein the one or more measurements are performed to determine a location of: the first UE, one or more target UEs other than the first UE, or both. The first UE may send a message indicative of the one or more measurements, wherein the message is sent via multicast wireless communication from the first UE to a group of devices comprising a plurality of other UEs.

### RELATED APPLICATIONS

This application claims the benefit of Greek application No. 20220100441, filed May 26, 2022, entitled “MULTICAST POSITIONING MEASUREMENT REPORTING IN SIDELINK”, which is assigned to the assignee hereof, and incorporated herein in its entirety by reference.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (SL). A positioning session between UEs may be conducted to perform positioning measurements using SL RF signals, and UEs can coordinate such SL positioning sessions to ensure efficient use of bandwidth and other wireless resources.

### BRIEF SUMMARY

An example method at first user equipment (UE) of reporting one or more measurements in a sidelink (SL) positioning session, according to this disclosure, may comprise obtaining, at the first UE, a positioning configuration related to the SL positioning session. The method also may comprise performing one or more measurements of one or more radio frequency (RF) signals at the first UE in accordance with the positioning configuration, wherein the one or more measurements are performed to determine a location of: the first UE, one or more target UEs other than the first UE, or both. The method also may comprise sending a message indicative of the one or more measurements, wherein the message is sent via multicast wireless communication from the first UE to a group of devices comprising a plurality of other UEs.

An example method at a second user equipment (UE) of enabling reporting of one or more measurements in a sidelink (SL) positioning session by a first UE, according to this disclosure, may comprise receiving, at a second UE via SL communication from the first UE, a message indicative of one or more measurements of one or more radio frequency (RF) signals, the one or more measurements performed by first UE, wherein the message is received via multicast wireless communication from the first UE, and the message comprises an identifier common to a group of devices comprising the second UE and at least one additional UE other than the first UE. The method also may comprise based on the one or more measurements: (i) determining a location of the first UE, one or more target UEs other than the first UE, or both. The method also may comprise (ii) performing one or more additional measurements. The method also may comprise (iii) both.

An example first user equipment (UE) for reporting one or more measurements in a sidelink (SL) positioning session, according to this disclosure, may comprise a transceiver, a memory, one or more processors communicatively coupled with the transceiver and the memory, wherein the one or more processors are configured to obtain a positioning configuration related to the SL positioning session. The one or more processors further may be configured to perform one or more measurements of one or more radio frequency (RF) signals at the first UE in accordance with the positioning configuration, wherein the one or more measurements are performed to determine a location of: the first UE, one or more target UEs other than the first UE, or both. The one or more processors further may be configured to send a message indicative of the one or more measurements, wherein the message is sent via multicast wireless communication via the transceiver to a group of devices comprising a plurality of other UEs.

An example second UE for enabling reporting of one or more measurements in a sidelink (SL) positioning session by a first UE, according to this disclosure, may comprise a transceiver, a memory, one or more processors communicatively coupled with the transceiver and the memory, wherein the one or more processors are configured to receive, with the transceiver via SL communication from the first UE, a message indicative of one or more measurements of one or more radio frequency (RF) signals, the one or more measurements performed by first UE, wherein: the message is received via multicast wireless communication from the first UE, and the message comprises an identifier common to a group of devices comprising the second UE and at least one additional UE other than the first UE. The one or more processors further may be configured to, based on the one or more measurements: (i) determine a location of the first UE, one or more target UEs other than the first UE, or both. The one or more processors further may be configured to (ii) perform one or more additional measurements. The one or more processors further may be configured to (iii) both.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIGS. 3A-3C are simplified diagrams of scenarios in which sidelink (SL) positioning may be used to determine the position of a target user equipment (UE).

FIGS. 4A and 4B are diagrams illustrating a scenario in which measurement reporting is performed using unicast messaging to multiple receiving UEs.

FIGS. 5A and 5B are diagrams illustrating a scenario in which measurement reporting is performed using multicast messaging to multiple receiving UEs.

FIGS. 6A-6C are diagrams providing examples of some communication layers that may be used for measurement reporting, according to some embodiments.

FIG. 7 is a flow diagram of a method at first UE of reporting one or more measurements in a SL positioning session, according to an embodiment.

FIG. 8 a flow diagram of a method at a second UE of enabling reporting of one or more measurements in a SL positioning session by a first UE, according to an embodiment.

FIG. 9 is a block diagram of an embodiment of a UE, which can be utilized in embodiments as described herein.

FIG. 10 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Position determination of one or more UEs may be based at least in part on measurements of signals performed by a first UE. In some instances, it may be desirable to send these measurements from the first UE to a plurality of other UEs. This can be done, for example, to perform additional measurements (e.g., and RTT determination) and/or to allow the other UEs to determine their position and/or the position of the first UE. However, sending these measurements from the first UE to each of the other UEs can be inefficient because the first UE may send each of the other UEs its own separate message, which may have its own overhead. Embodiments herein allow for a first UE to combine multiple messages in a single message to a plurality of other UEs, which can make more efficient use of available bandwidth resources. Additional details regarding such embodiments are provided after a discussion of relevant technology.

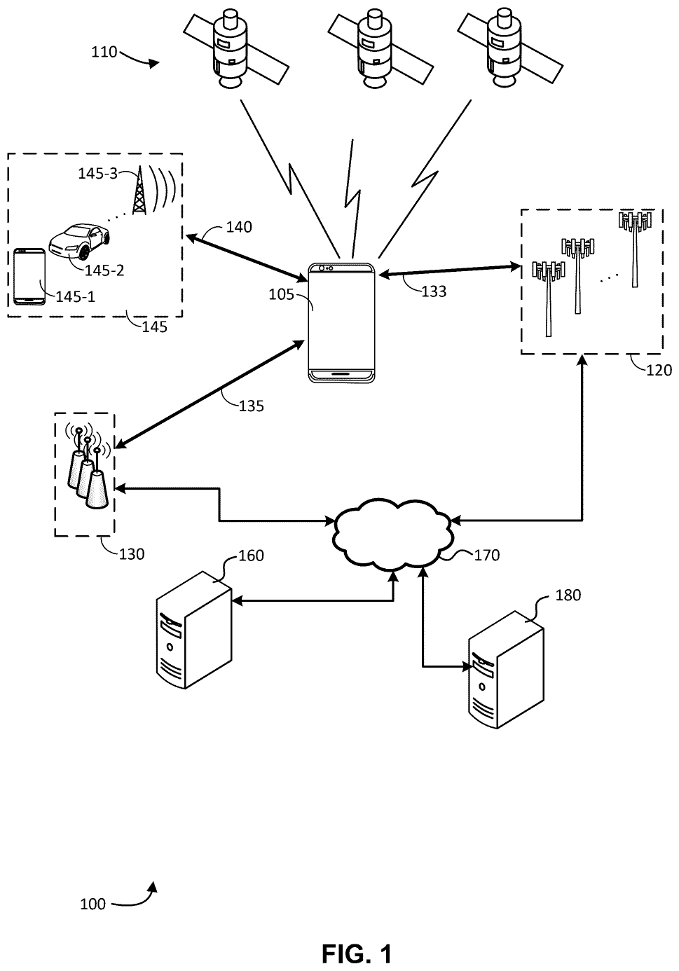

FIG. 1 is a simplified illustration of a positioning system 100 in which a mobile device 105, location server 160, and/or other components of the positioning system 100 can use the techniques provided herein for providing positioning measurement reporting in sidelink (SL) for positioning of the mobile device 105, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the mobile device 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computer system configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other mobile devices communicatively coupled with a cellular or other mobile network (e.g., network 170). When one or more other mobile devices 145 are used in the position determination of a particular mobile device 105, the mobile device 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and mobile device 105 may comprise SL and/or similar Device-to-Device (D2D) communication technologies. Sidelink (SL), which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another mobile device) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

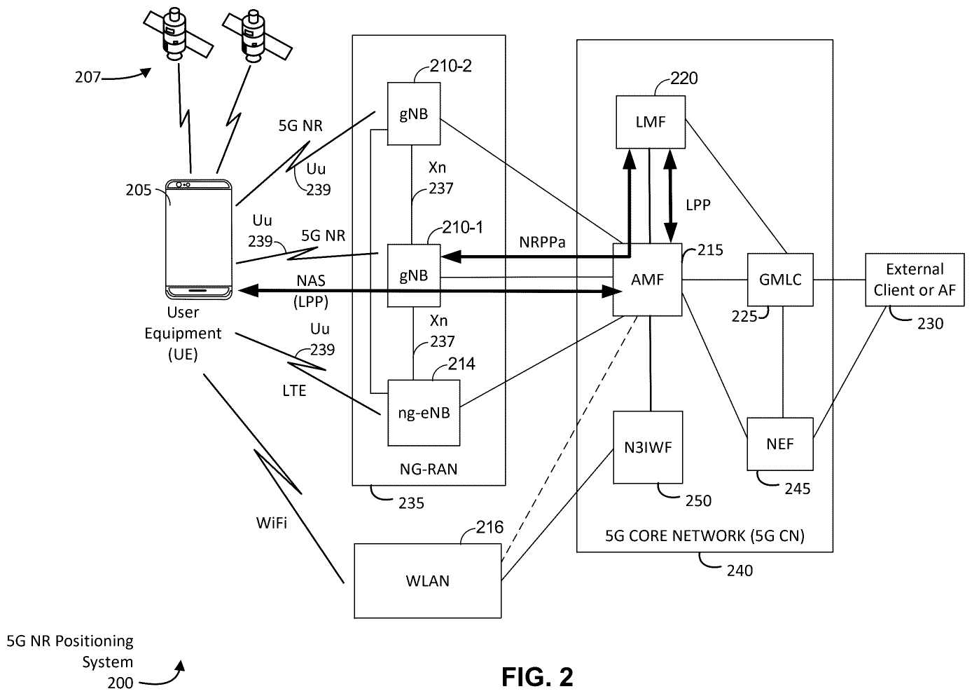

FIG. 2 shows a diagram of a 5G NR positioning system 200, illustrating an embodiment of a positioning system (which may correspond to at least a portion of a larger positioning system as described herein, such as the positioning system 100 of FIG. 1) implementing 5G NR. The 5G NR positioning system 200 may be configured to determine the location of a user equipment (UE) 205 (which may correspond with mobile device 105 of FIG. 1) by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations described elsewhere herein, and the WLAN 216 may correspond with one or more access points described elsewhere herein. Optionally, the 5G NR positioning system 200 additionally may be configured to determine the location of a UE 205 by using an LMF 220 (which may correspond with a location server as described elsewhere herein) to implement the one or more positioning methods. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 207. As previously indicated, satellites 207 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 207 may comprise NTN satellites that may be communicatively coupled with the LMF 220 and may operatively function as a TRP (or TP) in the NG-RAN 235. As such, satellites 207 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 207, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like one or more RATs as described elsewhere herein) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to an external client as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations as described elsewhere herein and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., access points, as described elsewhere herein). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

In a 5G NR positioning system 200, positioning methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of SL signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 207), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

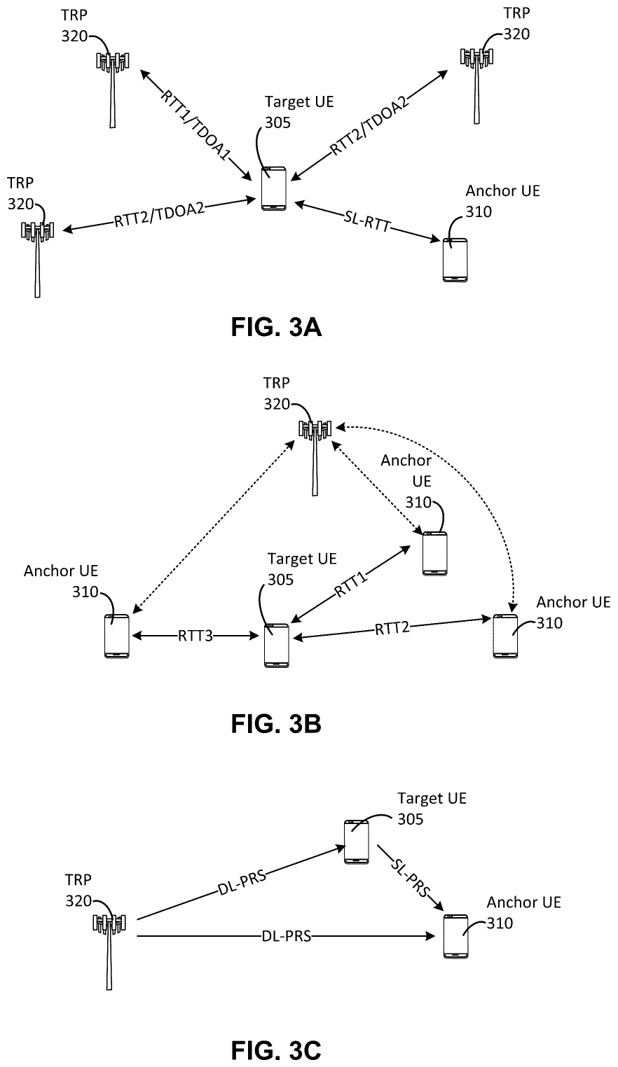

FIGS. 3A-3C are simplified diagrams of scenarios in which SL positioning may be used to determine the position of a target UE 305, according to some embodiments. One or more anchor UEs 310 may be used to send and/or receive reference signals via SL. As illustrated, positioning may be further determined using one or more base stations 320 (a Uu interface). It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three base stations 320. In this configuration, the target UE 305 may be in coverage range for DL and/or UL signals via Uu connections with the base stations 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the SL connection between the target UE 305 and anchor UE 310.

The diagram of FIG. 3B illustrates a configuration in which the positioning of a target UE 305 may SL-only positioning/ranging. In this configuration, the target UE 305 may perform RTT measurements via SL connections between a plurality of anchor UEs 310. In this example, the target UE 305 may not be in UL coverage of the base station 320, and therefore each anchor UE 310 may report RTT measurement information to the network of via a Uu connection between each anchor UE 310 and the base station 320. (In cases in which a UE relays information between a remote UE and a base station, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the base station 320, the target UE 305 may report RTT measurements directly to the base station 320. In some embodiments, no base station 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the base station 320, and the target UE 305 sending a reference signal (SL-PRS) to the anchor UE 310. The positioning of the target UE can be determined based on known positions of the base station 320 and anchor UE 310 and a time difference between a time at which the anchor UE 310 receiving the reference signal from the base station 320 and a time at which the anchor UE 310 receives the reference signal from the target UE 305.

As previously discussed, the use of SL positioning (e.g., SL-only or Uu/SL positioning, as illustrated in FIGS. 3A-3C) may utilize a Resource Pool for Positioning (RP-P). RP-P may be conveyed to UEs via a SL configuration (e.g., using techniques described hereafter), and may designate particular resource pools for SL reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via SL for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” SL positioning in which SL positioning is performed using one or more network-connected UEs, in which case network-based resource allocation may be received by a network-connected UE via a Uu interface with a base station (e.g., via Downlink Control Information (DCI) or Radio Resource Control (RRC)). Tx resource pools for “Mode 2” SL positioning in which autonomous resource selection is performed by UEs without network-based resource allocation. Resource pools may further comprise Rx resource pools, which may be used in either Mode 1 or Mode 2 SL positioning. Each RP-P configuration may be relayed via a physical SL control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR).

According to some embodiments, exceptional RP-P can be designated and used in circumstances in which it may not be desirable or possible to perform SL positioning via the available resource pools of non-exceptional RP-P for SL. Such exceptional cases may include situations similar to those that trigger the use of exceptional resource pools for communication, such as situations in which there may be physical layer problems, before the UE finishes and initiated connection, or during a handover of the UE. As with non-exceptional RP-P for SL, exceptional RP-P for SL may be configured or preconfigured, and may be allocated by the network or autonomously selected (e.g., used in Mode 1 or Mode 2 SL positioning). Further, according to some embodiments, exceptional RP-P may be preconfigured, preloaded, and/or hardcoded into UEs for different geographic regions or areas. Different countries, for example, may designate particular resources for exceptional RP-P in cases of public safety. Exceptional RP-P may be configured via dedicated signaling (e.g., PC5) and/or configured via System Information Block (SIB) via a Uu interface. In some embodiments, the exceptional RP-P may be broadcasted during the positioning session setup phase or discovery phase of a UE. Additionally or alternatively, exceptional RP-P may be assigned or allocated using resource reservation techniques.

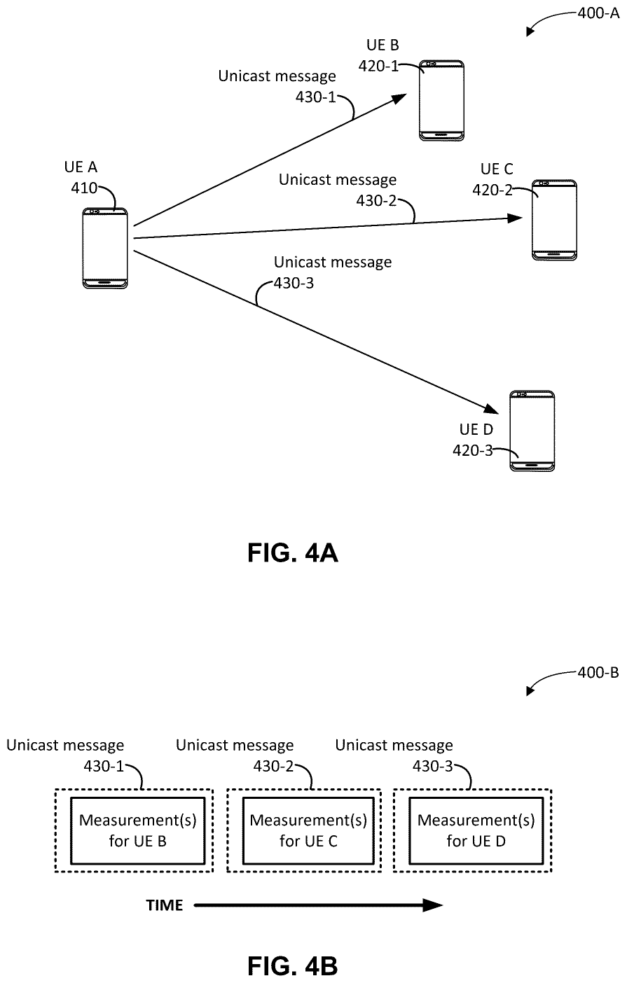

As previously noted, it may be desirable in an SL positioning session (e.g., in the manner illustrated in FIGS. 3A-3C) for a measuring UE to perform one or more measurements and send information indicative of the one or more measurements (e.g., RSTD, AoA, etc.) to a plurality of other UEs. In such instances, the measuring UE may comprise a target UE or an anchor UE. Further, the plurality of other UEs may comprise anchor UEs and/or target UEs. (SL positioning sessions may be used to determine the location of a single target UE or multiple target UEs at the same time.) However, the sending of this measurement information to a plurality of other UEs may be done in a relatively inefficient manner. FIGS. 4A and 4B help illustrate this inefficient communication in more detail.

FIG. 4A is a diagram illustrating a scenario 400-A in which UE A 410 (a measuring UE) sends measurement information to UE B 420-1, UE C 420-2, and UE D 420-3 (which may be referred to herein collectively and generically as receiving UEs 420). Traditionally, when sending the measurement information, UE A 410 would send measurement information to each receiving UE 420 with a respective unicast message (collectively and generically referred to herein as unicast messages 430). In the example of a FIG. 4A, UE A 410 sends a first unicast message 430-1 to UE B 420-1, a second unicast message 430-2 to UE C 420-2, and a third unicast message 430-3 to UE D 420-3.

FIG. 4B is a time diagram 400-B illustrating an example of how the unicast messages 430 of the scenario 400-A of FIG. 4A may be transmitted. As illustrated, each unicast message 430 may be transmitted separately such that the first unicast message 430-1 is sent to UE B 420-1, the second unicast message 430-2 is sent to UE C 420-2, and the third unicast message 430-3 is sent to UE C 420-3 and series, one after the other. The measurement(s) for each receiving UE 420 may be unique, and therefore a separate set of measurements may be needed for each receiving UE. Because each unicast message 430 may have its own overhead, the use of multiple messages in this manner may be a relatively inefficient use of bandwidth.

With this in mind, embodiments herein provide for enabling a measuring UE (e.g., UE A) to send the measurements to a plurality of receiving UEs (e.g., UE B, UE C, and UE D) in a single multicast message. As discussed in more detail hereafter, different communication layers may be used, depending on desired functionality. Further, changes in applicable protocols may be made to enable such multicast messaging.

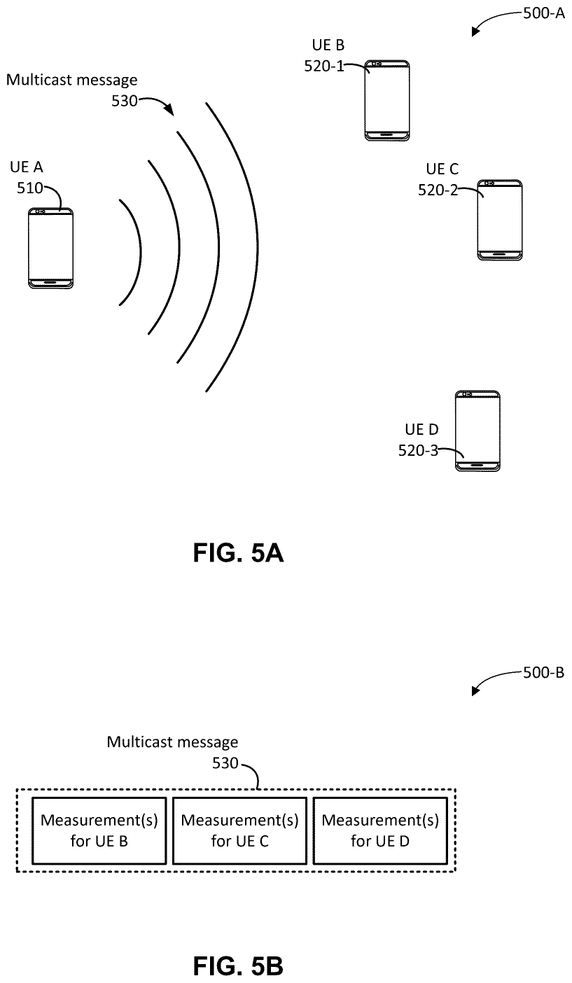

FIG. 5A is a diagram illustrating a scenario 500-A, similar to scenario 400-A of FIG. A in which UE A 510 (a measuring UE) sends measurement information to UE B 520-1, UE C 520-2, and UE D 520-3 (which may be referred to herein collectively and generically as receiving UEs 520). Here, rather than sending individual unicast transmissions, UE A 510 sends a multicast message 530. As indicated in the corresponding timing diagram 500-B of FIG. 5B, the multicast message 530 may multiplex measurement information to the intended UEs. In this way, the multicast message 530 may contain relevant information for each receiving UE 520. When receiving the multicast message 530, each receiving UE 520 can extract its own relevant regimen data and discard information intended for other UEs.

The advantages of this approach can be realized in various scenarios. For example, in joint positioning scenarios (for positioning a plurality of UEs at the same time) in which information provided by UE A 510 about UE B 520 may be relevant to all UEs participating in the joint session, sending a multicast message 530 to all receiving UEs 520 may be more efficient. Not only does this allow for the reduction of overhead, but may also allow for the combination of measurement information to different receiving UEs in cases where same measurement information is intended for multiple receiving UEs. According to some embodiments, in addition to measurement information (e.g., one or more sets of one or more measurements), a multicast message from the measuring UE may include one or more timestamps corresponding to the measurement(s) and/or other information and/or information elements (IEs) related to the measurement(s).

As noted, the content of the measurement information may vary, depending on the scenario. Different types of positioning may result in different measurement information. For example, for RTT-based positioning, a measuring UE may provide measure ToA information, allowing a receiving UE to determine the RTT. The measurement information may include additional or alternative types of measurements such as RSTD, AoA, and the like. Further, the measurement information provided in the multicast message may allow a receiving device to determine the location of one or more UEs, including its own location, the location of the measuring UE, and/or the location of other UEs participating in the SL positioning session.

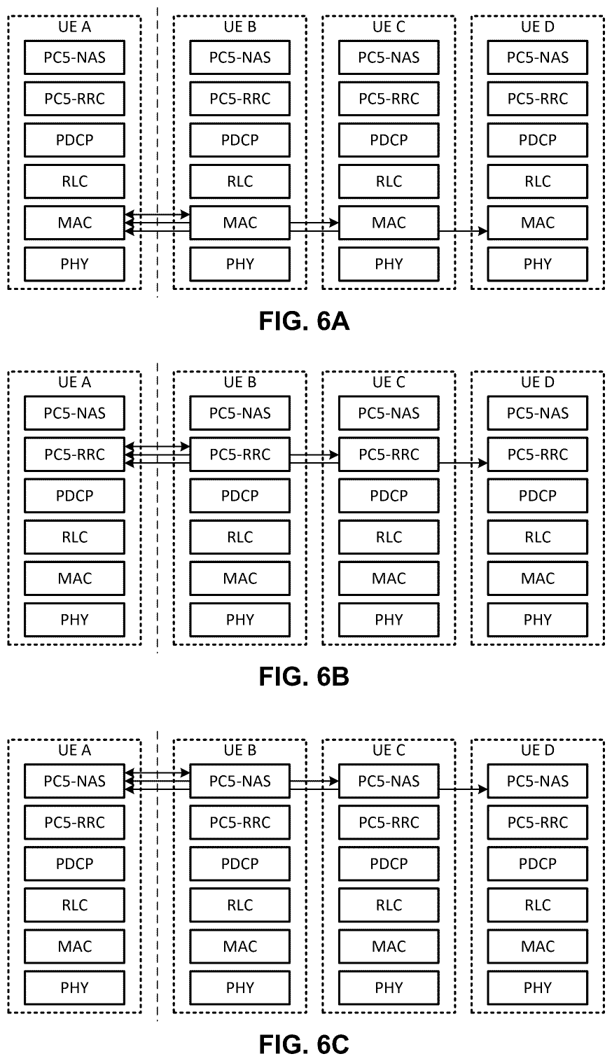

Depending on desired functionality, a multicast message transmitted by a measuring UE may be sent using any of a variety of different communication layers. FIGS. 6A-6B provide examples of some communication layers that may be used, according to some embodiments.

FIG. 6A is an illustration of various communication layers that may be utilized by UE A (the measuring UE) to communicate the multicast message with the measurement information to a plurality of receiving UEs: UE B, UE C, and UE D. The communication layers, which are defined and utilized in relevant wireless communication standards (e.g., 3GPP standards relating to 5G NR) include a physical (PHY) layer, a media access control (MAC) layer, a radio link control (RLC) layer, a packet data convergence protocol (PDCP) layer, a PC5 radio resource control (RRC) layer (as used herein, the term PC5 may be used interchangeably with SL), and a PC5 non-access stratum (NAS) layer. According to some embodiments, the various communication layers of the various UEs illustrated in FIG. 6A (and FIGS. 6B and 6C) may comprise communication layers in a PC5 control plane (CP) protocol stack.

As illustrated in FIG. 6A, according to some embodiments, UE A may transmit a multicast message with the measurement information (relating to an SL positioning session) via a message sent via the MAC layer. this message may comprise, for example, a channel state information (CSI) report sent on the CP. Because applicable standards currently only provide for unicast reporting of positioning information via the MAC layer, embodiments may utilize a new multicast (or groupcast) MAC control element (MAC-CE) message that contains positioning measurements made by the measuring UE data, as well as the relevant identities of the receiving UEs. Different sets of one or more measurements may be tagged by the measuring UE with the ID of one or more receiving UEs for which the one or more tagged measurements is intended. Upon receiving the multicast message, a receiving UE may process the multicast message and identify the one or more measurements intended for the respective receiving UE based on whether the one or more measurements are associated with the UE ID of the respective UE.

As example, UE A may provide measurement information in a multicast message comprising a first set of measurements and a second set of measurements. The first set of measurements may be intended for UE B and UE C at the second set of measurements may be intended for UE D. As such, UE A may include the first set of measurements and second set of measurements in the multicast message, and associate IDs for UE B and UE C with the first set of measurements and associate the ID for UE D with the second set of measurements. Of course, the number of measurements and number of receiving UEs may vary, depending on situation. In addition to situations where a single set of measurements may be sent to multiple UEs, situations may exist where a single UE receives multiple sets of measurements. Again, each set of measurements between tagged with one or more UE IDs, identifying the UEs for which the set of measurements are intended. In some embodiments, the measuring UE may send measurement information via a multicast message to one or more non-UE devices via SL, in addition or as an alternative to sending the multicast message to one or more other UEs.

According to some embodiments, the multicasting of a MAC-CE message from the measuring UE comprising measurement information may be enabled using a logical channel ID (LCID). According to some embodiments, the LCID may be assigned to the group of UEs participating in the SL positioning session. As such, the LCID may be unique to the SL positioning session. Further, the LCID may be assigned by the entity organizing the SL positioning session. In Mode 1, for example, the LCID may be assigned to or otherwise associated with the group of UEs by an organizing location server (e.g., an organizing LMF in a 5G cellular network). In Mode 2, for example, the LCID may be assigned by an organizing UE. Depending on the circumstances of the positioning session, the organizing UE may comprise the measuring UE or a receiving UE. Further, the organizing UE may comprise a target UE (for which the positioning session is used to an estimated position) or an anchor UE (having a known location used to help estimate the position of one or more target UEs). In embodiments in which the LCID is used, the LCID may be embedded in the multicast MAC-CE message. A receiving UE may then determine whether the multicast message is intended for the receiving UE by determining whether the multicast message has an LCID associated with the receiving UE. The entity organizing the positioning session (e.g., a location server or organizing UE) may distribute the LCID to UEs participating in the SL positioning session prior to or during the positioning session. In some embodiments, the LCID may be included in positioning configuration information for the SL positioning session, sent to the various UEs participating.

FIG. 6B is an illustration showing how measurement information may be communicated in a multicast message from UE A via the RRC layer of the PC5 (SL) protocol stack. Similar to the MAC layer, the RRC layer currently may not be capable of being used to send a multicast message to report positioning information. Accordingly, embodiments may define and use a new multicast (or groupcast) RRC message. Similar to the discussion above regarding the MAC-CE message, this new multicast RRC message may comprise an identifier of a group defined by and/or identified in the SL positioning session and/or identifiers of individual receiving UEs (e.g., UE B, UE C, and UE D).

As shown in FIG. 6C, embodiments may utilize an NAS communication layer of PC5. Currently, the relevant SL standards do not define this communication layer well. However, according to some embodiments, a multicast message may be sent via the NAS layer, transmitted in a transparent RRC container.

According to some embodiments, multicast RRC as described herein messages may be acknowledged by receiving UEs. As such, retransmission of the multicast RRC message may be supported. In some embodiments, group sequence numbering can be implemented to track the messages and to implement PDCP retransmissions. For example, a first UE may have a sequence space of 1 to N, a second UE may have a sequence space of N+1 to 2N, ⅓ UE may have a sequence space of 2N+1 to 3N, and so forth.

According to some embodiments, the communication layer used to send the multicast message reporting measurement information from the measurement UE may be selected dynamically. In some embodiments, for example, the entity organizing the SL positioning session (e.g., a location server or organizing UE) may select the communication layer to use. In some embodiments, the measuring UE (e.g., UE A) may make the selection. Because MAC-layer messaging may be faster but more limiting, it may be utilized in certain circumstances, whereas upper-layer messaging (e.g., RRC or NAS) may be capable of communicating more information, but may not be as fast. Thus, the selection may be based on factors such as size of the multicast message payload, priority and/or speed required for the positioning session, and so forth.

Some embodiments may utilize encryption to help secure the transmission of position-related data (e.g., measurement information) between UEs in an SL positioning session. Accordingly, the multicast message sent by a measuring UE (e.g., UE A) may be encrypted using one or more encryption keys associated with SL positioning session. According to some embodiments, an organizing entity (e.g., a location server or organizing UE) may generate and distribute encryption keys to use in the SL positioning session prior to or at the beginning of the SL positioning session. The UEs participating in the SL positioning session (including the measuring UE and receiving UEs) may then encrypt and decrypt messages to each other using these encryption keys. The creation of such encryption keys may be performed in accordance with existing encryption protocols, for example.

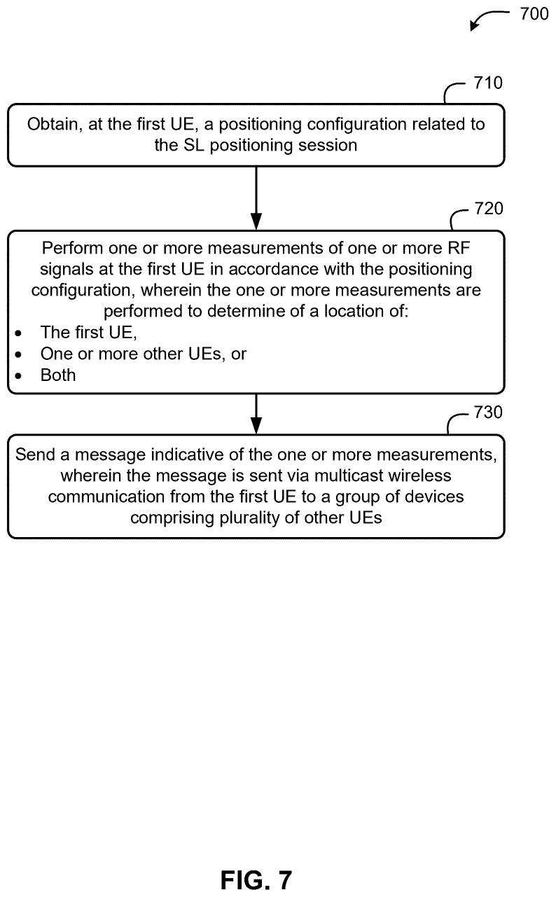

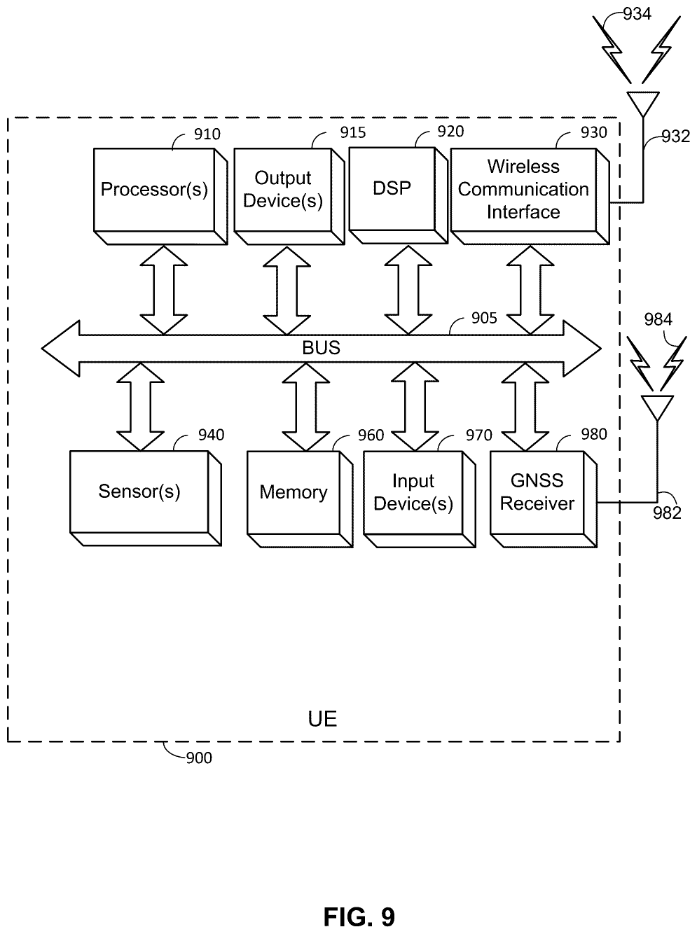

FIG. 7 is a flow diagram of a method 700 at first UE of reporting one or more measurements in a SL positioning session, according to an embodiment. The functionality of the first UE may correspond to a measuring UE (e.g., UE A) in previously described embodiments. Means for performing the functionality illustrated in one or more of the blocks shown in FIG. 7 may be performed by hardware and/or software components of a UE. Example components of a UE are illustrated in FIG. 9, which is described in more detail below.

At block 710, the functionality comprises obtaining, at the first UE, a positioning configuration related to the SL positioning session. Here, positioning configuration may comprise information for conducting the SL positioning session, which may be determined by an organizing entity such as a location server or organizing UE. In such instances, the positioning configuration may be obtained by receiving a message from the location server or organizing UE. In some instances, the first UE may comprise the organizing UE, in which case obtaining the positioning configuration may comprise generating the positioning configuration (e.g., based on capability information provided by other UEs participating in the SL positioning session).

For the first UE, the positioning configuration may comprise information for performing positioning-related measurements, such as type of measurement(s) to be performed (e.g., ToA, RSTD, RSRP, RTT, TDOA, AoA, etc.), accuracy and/or granularity requirements, the timing and/or frequency used by the RF signal(s) to be measured by the first UE, or combination thereof. According to some embodiments, the positioning configuration may further indicate what measurement information the first UE is to send and/or the UEs to which the measurement information is to be sent.

Means for performing functionality at block 710 may comprise a bus 905, processor(s) 910, DSP 920, wireless communication interface 930, sensors 940, memory 960, and/or other components of a UE 900, as illustrated in FIG. 9 and described hereafter.

At block 720, the functionality comprises performing one or more measurements of one or more RF signals at the first UE in accordance with the positioning configuration, wherein the one or more measurements are performed to determine a location of the first UE, one or more target UEs other than the first UE, or both. Here, the one or more RF signals may be sent by other UEs participating in the SL positioning session, which may include the one or more target UEs for which location is to be determined. These signals may comprise reference signals used for positioning, such as PRS signals (e.g., SL-PRS), SRS, CSI-RS, SSB, etc.

As noted elsewhere herein, determining the location of a target device may comprise determining an absolute location, a relative location, or a range of the target device to one or more other devices. As such, according to some embodiments of the method 700, for a target device comprising the first UE or one or the one or more target UEs, determining the location of the target device comprises determining a location of the target device in a coordinate system, a location of the target device, relative to another device or structure, or a range between the target device and another device, or a combination thereof.

Means for performing functionality at block 720 may comprise a bus 905, processor(s) 910, DSP 920, wireless communication interface 930, sensors 940, memory 960, and/or other components of a UE 900, as illustrated in FIG. 9 and described hereafter.

At block 730, the functionality comprises sending a message indicative of the one or more measurements, wherein the message is sent via multicast communication from the first UE to a group of devices comprising plurality of other UEs. As indicated previously, multicast communication may comprise direct SL communication from the first UE to each of the plurality of other UEs in the group.

As previously indicated, embodiments may include one or more additional features, depending on desired functionality. According to some embodiments, for example, the plurality of other UEs comprise the one or more target UEs other than the first UE. According to some embodiments, the message may be sent via MAC-CE message. In such embodiments, the MAC-CE message may include a LCID (or other identifier) used by the group. As noted, the LCID may be assigned by an entity organizing the SL positioning session, and the entity organizing the SL positioning session may send the LCID to each UE of the group. Depending on desired functionality, the entity organizing the SL positioning session may comprise a location server or an organizing UE. According to some embodiments, the message may be sent via an RRC message or an NAS message. In some embodiments, the method may include, prior to sending the message, encrypting the message with the first UE, wherein the encrypting uses an encryption key specific to the group.

Means for performing functionality at block 730 may comprise a bus 905, processor(s) 910, DSP 920, wireless communication interface 930, sensors 940, memory 960, and/or other components of a UE 900, as illustrated in FIG. 9 and described hereafter.

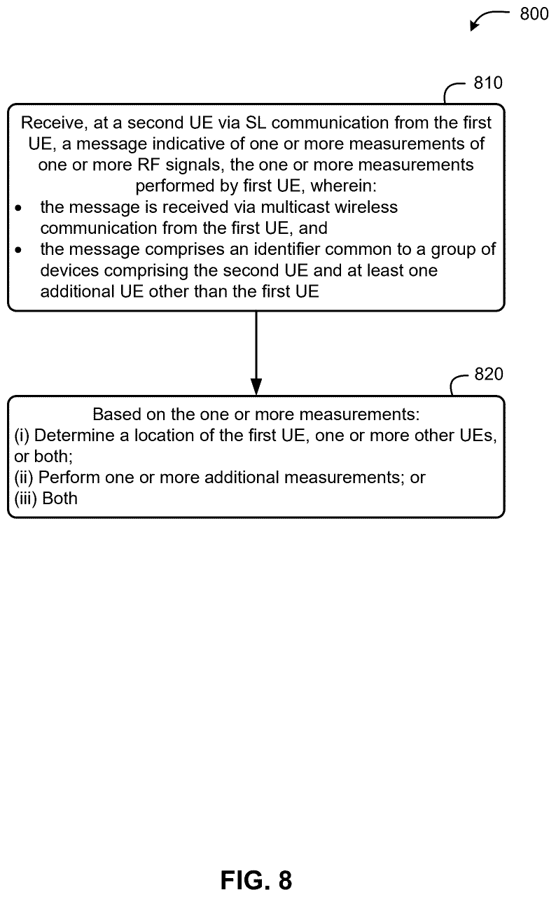

FIG. 8 is a flow diagram of a method 800 at a second UE of enabling reporting of one or more measurements in a SL positioning session by a first UE, according to an embodiment. The functionality of the first UE may correspond to a receiving UE (e.g., UE B, UE C, or UE D) in previously described embodiments. Means for performing the functionality illustrated in one or more of the blocks shown in FIG. 8 may be performed by hardware and/or software components of a UE. Example components of a UE are illustrated in FIG. 9, which is described in more detail below.

At block 810, the functionality comprises receiving, at a second UE via SL communication from the first UE, a message indicative of one or more measurements of one or more RF signals, the one or more measurements performed by first UE, wherein: the message is received via multicast wireless communication from the first UE, and the message comprises an identifier common to a group of devices comprising the second UE and at least one additional UE other than the first UE. Again, the type of measurement(s) performed may vary (e.g., ToA, RSTD, RSRP, RTT, TDOA, AoA, etc.), along with other aspects, such as accuracy and/or granularity, and so on. These aspects may be related to the type of positioning performed. According to some embodiments, a positioning configuration received by the second UE may indicate to the second UE what measurement information the first UE is to send.

Means for performing functionality at block 810 may comprise a bus 905, processor(s) 910, DSP 920, wireless communication interface 930, sensors 940, memory 960, and/or other components of a UE 900, as illustrated in FIG. 9 and described hereafter.

At block 820, the functionality comprises, based on the one or more measurements: (i) determining a location of the first UE, one or more target UEs other than the first UE, or both; (ii) performing one or more additional measurements; or (iii) doing both operations (i) and (ii). As previously indicated, the one or more measurements provided by the first UE may be used by the second UE to perform one or more additional measurements. This may be the case, for example, in RTT positioning, where the second UE determines an RTT measurement (e.g., based on a ToA measurement provided by the first UE). Additionally or alternatively, the second UE may use the one or more measurements provided by the first UE to determine a position estimate of the first UE, one or more target UEs, or both.

Means for performing functionality at block 820 may comprise a bus 905, processor(s) 910, DSP 920, wireless communication interface 930, sensors 940, memory 960, and/or other components of a UE 900, as illustrated in FIG. 9 and described hereafter.

As previously indicated, embodiments may include one or more additional features, depending on desired functionality. According to some embodiments, for example, receiving the message may further comprise identifying the one or more measurements within the message based at least in part on an UE-specific identifier corresponding to the second UE. As previously noted, a receiving UE such as the second UE may process the message received by the first UE to identify a portion of the message comprising one or more measurements intended for the second UE. To enable the second UE to identify the one or more measurements, one or more measurements may be tagged (e.g., associated with) with an identifier of the UE. According to some embodiments, the message may be received via a MAC-CE message. In such embodiments, the MAC-CE message may include a LCID (or other identifier) used by the group. As noted, the LCID may be assigned by an entity organizing the SL positioning session, and such embodiments may further include receiving, at the second UE, the LCID from the entity organizing the SL positioning session. Depending on desired functionality, the entity organizing the SL positioning session may comprise a location server or an organizing UE. According to some embodiments, the message may be received via an RRC message or an NAS message. In some embodiments, the method may include decrypting the message using an encryption key specific to the group.

FIG. 9 is a block diagram of an embodiment of a UE 900, which can be utilized as described herein above (e.g., in association with FIGS. 1-8). For example, the UE 900 can perform one or more of the functions of the either of the methods shown in FIG. 7 or 8 and/or the more general functionality of a UE (e.g., a measuring UE, a receiving UE, an organizing UE, a target UE, an anchor UE, and other such UEs) as described herein. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 900 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 900 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 910 or DSP 920.

The UE 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 900 (and/or processor(s) 910 or DSP 920 within UE 900). In some embodiments, then, such code and/or instructions can be used to configure and/or adapt a general-purpose computer (or other device) to perform one or more operations in accordance with the described methods.

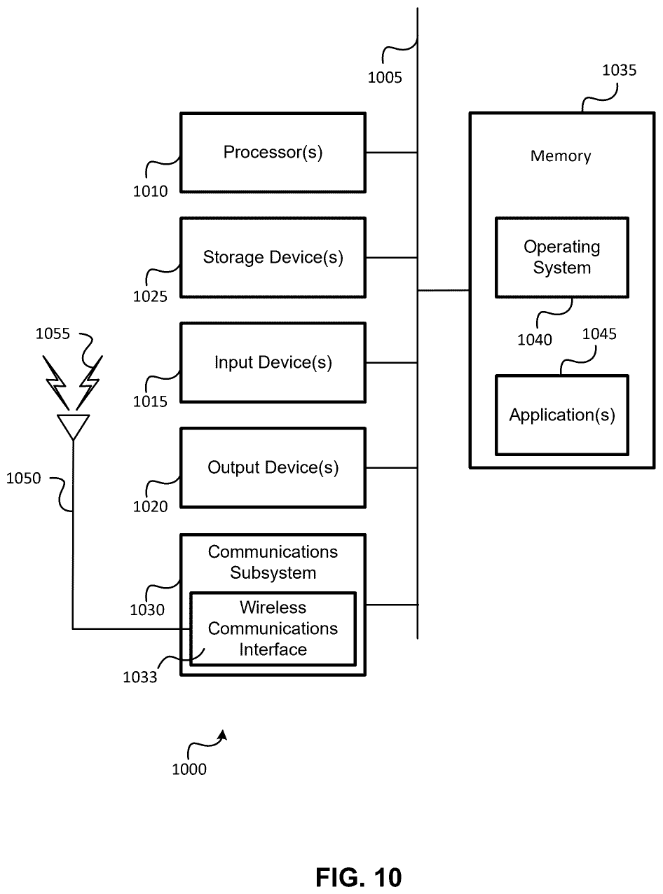

FIG. 10 is a block diagram of an embodiment of a computer system 1000, which may be used, in whole or in part, to provide the functions of one or more network components as described in the embodiments herein (e.g., a location server). It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including a User Equipment (UE), base stations and/or other TRPs, and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computer systems such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method at first user equipment (UE) of reporting one or more measurements in a sidelink (SL) positioning session, the method comprising: obtaining, at the first UE, a positioning configuration related to the SL positioning session; performing one or more measurements of one or more radio frequency (RF) signals at the first UE in accordance with the positioning configuration, wherein the one or more measurements are performed to determine a location of: the first UE, one or more target UEs other than the first UE, or both; and sending a message indicative of the one or more measurements, wherein the message is sent via multicast wireless communication from the first UE to a group of devices comprising a plurality of other UEs.
Clause 2. The method of clause 1, wherein the plurality of other UEs comprise the one or more target UEs.
Clause 3. The method of any one of clauses 1-2 wherein the message is sent via a media access control-control element (MAC-CE) message.
Clause 4. The method of clause 3 wherein the MAC-CE message includes a logical channel ID (LCID) used by the group.
Clause 5. The method of clause 4 wherein the LCID is assigned by an entity organizing the SL positioning session; and the entity organizing the SL positioning session sends the LCID to each UE of the group.
Clause 6. The method of clause 5 wherein the entity organizing the SL positioning session comprises a location server or an organizing UE.
Clause 7. The method of any one of clauses 1-2 wherein the message is sent via a radio resource control (RRC) message.
Clause 8. The method of any one of clauses 1-2 wherein the message is sent via a non-access stratum (NAS) message.
Clause 9. The method of any one of clauses 1-8 further comprising, prior to sending the message, encrypting the message with the first UE, wherein the encrypting uses an encryption key specific to the group.
Clause 10. The method of any one of clauses 1-9 wherein for a target device comprising the first UE or one or the one or more target UEs, determining the location of the target device comprises determining: a location of the target device in a coordinate system, a location of the target device, relative to another device or structure, or a range between the target device and another device, or a combination thereof.
Clause 11. A method at a second user equipment (UE) of enabling reporting of one or more measurements in a sidelink (SL) positioning session by a first UE, the method comprising: receiving, at a second UE via SL communication from the first UE, a message indicative of one or more measurements of one or more radio frequency (RF) signals, the one or more measurements performed by first UE, wherein: the message is received via multicast wireless communication from the first UE, and the message comprises an identifier common to a group of devices comprising the second UE and at least one additional UE other than the first UE; and based on the one or more measurements: (i) determining a location of the first UE, one or more target UEs other than the first UE, or both; (ii) performing one or more additional measurements; or (iii) both.
Clause 12. The method of clause 11, wherein receiving the message further comprises identifying the one or more measurements within the message based at least in part on an UE-specific identifier corresponding to the second UE.
Clause 13. The method of any one of clauses 11-12 wherein the message is received via a media access control-control element (MAC-CE) message.
Clause 14. The method of any one of clauses 11-13 wherein the MAC-CE message includes a logical channel ID (LCID) used by the group.
Clause 15. The method of clause 14 wherein the LCID is assigned by an entity organizing the SL positioning session, and the method further includes receiving, at the second UE, the LCID from the entity organizing the SL positioning session.
Clause 16. The method of clause 15 wherein the entity organizing the SL positioning session comprises a location server or an organizing UE.
Clause 17. The method of any one of clauses 11-12 wherein the message is received via a radio resource control (RRC) message.
Clause 18. The method of any one of clauses 11-12 wherein the message is received via a non-access stratum (NAS) message.
Clause 19. The method of any one of clauses 11-18 further comprising decrypting the message using an encryption key specific to the group.
Clause 20. A first user equipment (UE) for reporting one or more measurements in a sidelink (SL) positioning session, the first UE comprising: a transceiver; a memory; and one or more processors communicatively coupled with the transceiver and the memory, wherein the one or more processors are configured to: obtain a positioning configuration related to the SL positioning session; perform one or more measurements of one or more radio frequency (RF) signals at the first UE in accordance with the positioning configuration, wherein the one or more measurements are performed to determine a location of: the first UE, one or more target UEs other than the first UE, or both; and send a message indicative of the one or more measurements, wherein the message is sent via multicast wireless communication via the transceiver to a group of devices comprising a plurality of other UEs.
Clause 21. The first UE of clause 20, wherein the one or more processors are configured to send the message via a media access control-control element (MAC-CE) message.
Clause 22. The first UE of clause 21 wherein the one or more processors are configured to include, in the MAC-CE message, a logical channel ID (LCID) used by the group.
Clause 23. The first UE of clause 20 wherein the one or more processors are configured to send the message via a radio resource control (RRC) message.
Clause 24. The first UE of clause 20 wherein the one or more processors are configured to send the message via a non-access stratum (NAS) message.
Clause 25. The first UE of any one of clauses 20-24 wherein the one or more processors are further configured to, prior to sending the message, encrypt the message with the first UE, wherein the encrypting uses an encryption key specific to the group.
Clause 26. The first UE of any one of clauses 20-25 wherein, to determine the location of a target device comprising the first UE or one or the one or more target UEs, the one or more processors are configured to determine a location of the target device in a coordinate system, a location of the target device, relative to another device or structure, or a range between the target device and another device, or a combination thereof.
Clause 27. A second UE for enabling reporting of one or more measurements in a sidelink (SL) positioning session by a first UE, the second UE comprising: a transceiver; a memory; and one or more processors communicatively coupled with the transceiver and the memory, wherein the one or more processors are configured to: receive, with the transceiver via SL communication from the first UE, a message indicative of one or more measurements of one or more radio frequency (RF) signals, the one or more measurements performed by first UE, wherein: the message is received via multicast wireless communication from the first UE, and the message comprises an identifier common to a group of devices comprising the second UE and at least one additional UE other than the first UE; and based on the one or more measurements: (i) determine a location of the first UE, one or more target UEs other than the first UE, or both; (ii) perform one or more additional measurements; or (iii) both.
Clause 28. The second UE of clause 27, wherein, to receive the message, the one or more processors are configured to identify the one or more measurements within the message based at least in part on an UE-specific identifier corresponding to the second UE.
Clause 29. The second UE of any one of clauses 27-28 where the one or more processors are further configured to decrypt the message using an encryption key specific to the group.
Clause 30. The second UE of any one of clauses 27-29 wherein the one or more processors are configured to receive the message via a media access control-control element (MAC-CE) message.
Clause 31. An apparatus having means for performing the method of any one of clauses 1-19.

Clause 32. A non-transitory computer-readable medium storing instructions, the instructions comprising code for performing the method of any one of clauses 1-19.

What is claimed is:

1. A method at first user equipment (UE) of reporting one or more measurements in a sidelink (SL) positioning session, the method comprising:
obtaining, at the first UE, a positioning configuration related to the SL positioning session;
performing one or more measurements of one or more radio frequency (RF) signals at the first UE in accordance with the positioning configuration, wherein the one or more measurements are performed to determine a location of:
the first UE,
one or more target UEs other than the first UE, or
both; and
sending a message indicative of the one or more measurements, wherein the message is sent via multicast wireless communication from the first UE to a group of devices comprising a plurality of other UEs.

2. The method of claim 1, wherein the plurality of other UEs comprise the one or more target UEs.

3. The method of claim 1, wherein the message is sent via a media access control-control element (MAC-CE) message.

4. The method of claim 3, wherein the MAC-CE message includes a logical channel ID (LCID) used by the group.

5. The method of claim 4, wherein
the LCID is assigned by an entity organizing the SL positioning session; and
the entity organizing the SL positioning session sends the LCID to each UE of the group.

6. The method of claim 5, wherein the entity organizing the SL positioning session comprises a location server or an organizing UE.

7. The method of claim 1, wherein the message is sent via a radio resource control (RRC) message.

8. The method of claim 1, wherein the message is sent via a non-access stratum (NAS) message.

9. The method of claim 1, further comprising, prior to sending the message, encrypting the message with the first UE, wherein the encrypting uses an encryption key specific to the group.

10. The method of claim 1, wherein for a target device comprising the first UE or one or the one or more target UEs, determining the location of the target device comprises determining:
a location of the target device in a coordinate system,
a location of the target device, relative to another device or structure, or
a range between the target device and another device, or
a combination thereof.

11. A method at a second user equipment (UE) of enabling reporting of one or more measurements in a sidelink (SL) positioning session by a first UE, the method comprising:
receiving, at a second UE via SL communication from the first UE, a message indicative of one or more measurements of one or more radio frequency (RF) signals, the one or more measurements performed by first UE, wherein:
the message is received via multicast wireless communication from the first UE, and
the message comprises an identifier common to a group of devices comprising the second UE and at least one additional UE other than the first UE; and
based on the one or more measurements:
(i) determining a location of the first UE, one or more target UEs other than the first UE, or both;
(ii) performing one or more additional measurements; or
(iii) both.

12. The method of claim 11, wherein receiving the message further comprises identifying the one or more measurements within the message based at least in part on an UE-specific identifier corresponding to the second UE.

13. The method of claim 11, wherein the message is received via a media access control-control element (MAC-CE) message.

14. The method of claim 13, wherein the MAC-CE message includes a logical channel ID (LCID) used by the group.

15. The method of claim 14, wherein the LCID is assigned by an entity organizing the SL positioning session, and the method further includes receiving, at the second UE, the LCID from the entity organizing the SL positioning session.

16. The method of claim 15, wherein the entity organizing the SL positioning session comprises a location server or an organizing UE.

17. The method of claim 11, wherein the message is received via a radio resource control (RRC) message.

18. The method of claim 11, wherein the message is received via a non-access stratum (NAS) message.

19. The method of claim 11, further comprising decrypting the message using an encryption key specific to the group.

20. A first user equipment (UE) for reporting one or more measurements in a sidelink (SL) positioning session, the first UE comprising:
a transceiver;
a memory; and
one or more processors communicatively coupled with the transceiver and the memory, wherein the one or more processors are configured to:
obtain a positioning configuration related to the SL positioning session;
perform one or more measurements of one or more radio frequency (RF) signals at the first UE in accordance with the positioning configuration, wherein the one or more measurements are performed to determine a location of:
the first UE,
one or more target UEs other than the first UE, or
both; and
send a message indicative of the one or more measurements, wherein the message is sent via multicast wireless communication via the transceiver to a group of devices comprising a plurality of other UEs.

21. The first UE of claim 20, wherein the one or more processors are configured to send the message via a media access control-control element (MAC-CE) message.

22. The first UE of claim 21, wherein the one or more processors are configured to include, in the MAC-CE message, a logical channel ID (LCID) used by the group.

23. The first UE of claim 20, wherein the one or more processors are configured to send the message via a radio resource control (RRC) message.

24. The first UE of claim 20, wherein the one or more processors are configured to send the message via a non-access stratum (NAS) message.

25. The first UE of claim 20, wherein the one or more processors are further configured to, prior to sending the message, encrypt the message with the first UE, wherein the encrypting uses an encryption key specific to the group.

26. The first UE of claim 20, wherein, to determine the location of a target device comprising the first UE or one or the one or more target UEs, the one or more processors are configured to determine:
a location of the target device in a coordinate system,
a location of the target device, relative to another device or structure, or
a range between the target device and another device, or
a combination thereof.

27. A second UE for enabling reporting of one or more measurements in a sidelink (SL) positioning session by a first UE, the second UE comprising:
a transceiver;
a memory; and
one or more processors communicatively coupled with the transceiver and the memory, wherein the one or more processors are configured to:
receive, with the transceiver via SL communication from the first UE, a message indicative of one or more measurements of one or more radio frequency (RF) signals, the one or more measurements performed by first UE, wherein:
the message is received via multicast wireless communication from the first UE, and
the message comprises an identifier common to a group of devices comprising the second UE and at least one additional UE other than the first UE; and
based on the one or more measurements:
(i) determine a location of the first UE, one or more target UEs other than the first UE, or both;
(ii) perform one or more additional measurements; or
(iii) both.

28. The second UE of claim 27, wherein, to receive the message, the one or more processors are configured to identify the one or more measurements within the message based at least in part on an UE-specific identifier corresponding to the second UE.

29. The second UE of claim 27, where the one or more processors are further configured to decrypt the message using an encryption key specific to the group.

30. The second UE of claim 27, wherein the one or more processors are configured to receive the message via a media access control-control element (MAC-CE) message.
